(19) United States
(12) Patent Application Publication
(10) Pub. No.: US 2009/0205002 A1
(43) Pub. Date: Aug. 13, 2009

(54) VIDEO AND AUDIO CONTENT ON DEMAND ACCORDING TO TIME OF BROADCAST

(76) Inventor: Eliyahu Massiah, Ramat Gan (IL)

Correspondence Address: Fleit Gibbons Gutman Bongini & Bianco PL, 21355 EAST DIXIE HIGHWAY, SUITE 115, MIAMI, FL, 33180, US

(21) Appl. No.: 12/304,468

(22) PCT Filed: May 21, 2007
(86) PCT No.: PCT/IL07/00616

§ 371 Date: Dec. 11, 2008

Related U.S. Application Data
(60) Provisional application No. 60/802,164, filed on May 22, 2006.

(51) Int. Cl. H04N 7/173; G06Q 30/00; G06Q 50/00

(52) U.S. Cl. 725/87; 705/34; 705/26; 705/14

(57) ABSTRACT

A system and method for providing a content downloading service to a user and charging the user for the content. The content consists of audio or video content that is being broadcasted on a radio or TV station. The content is downloaded by the content provider to the user upon the user's requirement. The transaction between the service provider and the user is administered by the internet by a content server and a billing server.

### FIELD OF THE INVENTION

The present invention relates generally to the field of radio or video on demand.

### BACKGROUND OF THE INVENTION

The area of radio on demand (ROD) has grown extensively in the past decade after the evolution of wireless networks. Consumers are provided with Video on Demand (VOD), both on the internet and in cable television, so it's obvious that the next step is radio on demand.

There are many approaches to the field of ROD in the art. PCT application PCT/CA99/00568 discloses a method and system for providing individual subscribers vocal or instrumental music and educational. The radio station stores a collection of expressive works in a digital database and produces a categorized index which is stored at the radio station and at the subscriber s' radios. A subscriber uses the index to produce one or more lists each having at least one selected expressive work. When determined by the subscriber, the works on a selection list will be sequentially obtained from the radio station and played substantially immediately on receipt by the subscriber's personal radio. The categorized list needs to be updated constantly, in order to supply radio content that was played several minutes before the subscriber's selection, or sometimes while the subscriber selects content.

Another approach is depicted in PCT/US02/38800, providing personalized music playback over a network. A subscriber may cause a browser on his/her computer to connect to a server via which the subscriber may tune to one of a plurality of radio stations by selecting a hypertext link for the desired radio station. The subscriber may receive from the server a playlist of songs in the musical style of the radio station selected by the subscriber.

The playlist includes a plurality of unique identifiers for each song that indicate to the subscriber's media player, a location on the Internet from which the song may be transmitted to the media player for playback on the subscriber's computer. In addition to selecting a radio station and receiving a playlist, each subscriber requests songs to be included on a future playlist. Requests are aggregated to determine which songs are most requested. A subscriber request for a song may be time-delayed or satisfied in real-time.

None of the abovementioned ROD services and methods conclude the time and the radio station or radio source as the main characteristics. Furthermore, the subscriber can not select a plurality of contents from a plurality of radio stations or radio sources. ROD is especially useful for vehicles or any other locations where the subscriber wishes to be entertained. For example, Japanese patent application No. 2004045890 discloses a content providing server connected to an on-vehicle telematic device. The content providing server sends content data complying with a content request from a vehicle in response to the content request of an on-demand radio set. The on-vehicle telematic device receives the content data, generates a signal for radio from the content data, and sends the signal to the on-vehicle radio set.

An on-vehicle ROD characterized by the radio station and the time of the radio content data is a long felt need

### BRIEF DESCRIPTION OF THE FIGURES

In order to understand the invention and to see how it may be implemented in practice, a plurality of embodiments will now be described, by way of non-limiting example only, with reference to the accompanying drawings, in which

FIG. 1 schematically describes a block diagram of the system and its users and the connections thereof, according to one embodiment of the present invention;

FIG. 2 schematically describes a flow chart of the method of requesting and providing radio content, according to another embodiment of the present invention; and,

FIG. 3 schematically illustrates several methods of requesting media content and the steps following the request.

### SUMMARY OF THE INVENTION

The present invention discloses a method of providing a determined audio or video content to a subscriber, wherein said content is characterized by its broadcasting time, date and (station) frequency of broadcasting of said content comprising requesting said content by said subscriber, transmitting said request by over a network to a database, billing said subscriber by a predetermined sum of money, and providing said audio or video content to said subscriber.

The audio content is selected from a group consists of song, symphony, announcement, advertisement, propaganda broadcast, collection of sounds made by a bird or other animal, poetry, news, articles, interviews, or any combination thereof.

The video content is selected from a group consists of video clip, movie, TV show, announcement, advertisement, propaganda broadcast, news, articles, interviews, sport events or any combination thereof.

The method is especially adapted to subscribers while driving.

The method further comprising the step of pressing a bottom located on a radio while listening to an audio content in order to requesting said vocal content.

The method further comprises the step of billing the subscriber for providing said content.

It is another object of the present invention to disclose a system adapted to provide vocal content to a subscriber over a network wherein said content is requested by the subscriber according to the time, date and frequency of broadcasting of said content, comprising a processing module, adapted to receive subscriber's requests, a database, storing video and audio content, as well as subscribers communicating details and financial status, at least one end unit, connected to the processing module; adapted to send the request and receive the vocal content.

The end unit is especially a radio. The radio comprises a bottom adapted to send a request to the processing unit.

The end unit is selected from a group consists of mobile phone, FTP folder, computer, email account or any other device having communication means and free storage.

The system additionally comprising billing means, adapted to bill said subscriber according to the volume of content provided, the popularity of said content, memory consumption, duration, number of items provided, or any combination thereof.

The subscriber holds one or more accounts in the system, to ease the billing and money and/or money substitute transactions among senders, recipients and the 5 system.

The transactions performed after verification and/or identification and/or authentication and/or authorization, by means selected from a group consists of passwords, codes, private knowledge or any combination thereof.

The system is adapted to provide ring-tones to said subscribers.

The system is the beneficiary for some of the billing, according to arrangements between the subscriber, the radio station or TV channel and the system.

The value for charging the subscriber is limited by the subscriber for one or more actions, to control the charging and ensure that the sender's credit is sufficient before sending said message.

### DETAILED DESCRIPTION OF THE PREFERRED EMBODIMENTS

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide a means and a method of providing audio and video content to a subscriber over a network wherein the content is requested according to the time, date and frequency of broadcasting of said content.

The term ‘audio content (AC)’ refers hereinafter to song, symphony, announcement, advertisement, propaganda broadcast, collection of sounds made by a bird or other animal, poetry, news, articles, interviews, or any combination thereof.

The term ‘communicating means’ refers hereinafter to wireless or wires channels, either online communication, telephonic, on the internet, SMS, e-mail, MMS, facsimile messages or any of the like.

The term ‘ring tone’ refers hereinafter to the sound made by a telephone to indicate an incoming call. The term, however, is most often used to refer to the sounds available on mobile phones. This facility was originally provided so that people would be able to determine when their phone was ringing when in the company of other mobile phone owners. Newer phones let the subscriber s associate a different ring tone for each phonebook entry. Newer phones can also use short pieces of music as ring tones, and the sale of these has become a major success of the mobile music industry.

The present invention discloses means and methods for providing video and audio content to a subscriber. The subscriber requests the content by inputting the date, and time of which the content was broadcasted, as well as the frequency of broadcasting, mostly referring to the radio station or television channel. The subscriber is registered in the system, characterized in a non-limiting manner, at least by communicating model, such as email account or phone number, and by his financial status, which determines the parameters of the amount of allowed content to be provided, such as number of items, memory consumption of the items, duration, price, popularity, or any of the like.

The need for only three basic parameters date, time and frequency—facilitates the subscriber to request for specific contents. This way the subscriber avoids the research for the name of the content, creator, musician, reporter, or any of the like.

The main portion of the system consists of at least one server, designated to receive messages in one of the formats listed in the subsequent section. The server identifies the requested content and the requesting subscriber and subsequently delivers the following three messages:
1. A message to the user, through email, SMS, or on-line message to the user screen requesting confirmation of the content purchase.
2. A message to the content server to prepare carrying out a content transaction. The server may be independent from the system and located remotely and further owned by the title company who owns the IP of that specific song or video.
3. A message to the billing server notifying the billing server about an approaching transaction subject to subscriber confirmation.

The back-end system expects the following messages and formats:
1. An initial message, through the internet IP connection, or by SMS, or any internal message of a cable network by ways listed in a preceding section.
2. Message must contain the broadcasting station or channel, optionally the time of order and any identification means of the Sender. Sender identification which is mandatory may be derived from a cellular phone number rather than being part of the identification message.
3. Subscriber's identification is necessary for billing as well as for transmitting the content to the requesting user; In the event that user is pre-registered registered then this request can be associated to a certain credit-card or pay-pal account or any other paying method. When the user is not a registered user his cellular-phone number can be used to as a charging account. Upon registration, the user can also specify the communication channel to be used for receiving the ordered content. By default the content may be sent to a user by email via PC client downloading, or directly to his radio set/set-top-box that is equipped with downloading capability.
4. When a radio station is specified in the initial-message, the content is identified by the identifying server through available play lists of all the radio/TV stations and the timing data. When the radio/TV station is not specified or play-lists are not available to the system, the system can request identifying servers to resolve the query by means of automatic pattern recognition, or by collaborative work of people who work from their homes and fill in the queries.
5. Upon successful identification of the user and the requested content the system sends a confirmation message to the end-user, as well as transaction-messages to the billing-server and the content-server.
6. In the event that a user has confirmed the request, and agreed to the terms of the purchase, the content is sent to the receiving site of the user. If the user is not registered to receive content from the system the content can be stored at the downloading server, and the user may get the content from the downloading server through any available communication channel
7. A billing message is sent to the billing server.
   The front-end system

The user can use any of the following available means to compose a formal message to the back-end system:
1. SMS message sent to a pre-defined phone-number and that includes the station ID: for example: Send “88.1 FM” to the number “*MUSIC”
2. A Click on a given radio/TV station-name of a dedicated web site for that purpose.
3. a press on the TV remote control
4. any request on an adaptive website.

In another embodiment the system is configured in a single unit. The radio-set which comprises a digital processor for navigation, or other functions can be connected the internet or to a cellular network. The radio can be further equipped with a push button switch that Initiates the process of collecting time and station identification data and transmission of a content request to the system along with the associated necessary data, The radio-set of the car can be also equipped with a phone SIM card, for transmitting SMS messages that are automatically composed with all the collected information and transmitted by to the back-end system. A push button can be also incorporated into cable-TV set-top boxes, or into the web-sites of radio/TV stations.

The request is sent to the system, which comprises a processing unit and a database. The database stores video and audio content and retrieves the data which was broadcasted, according to parameters analyzed by the processing unit. The content is then sent to the subscriber, in video or audio formats, such as MPEG, WMA, zip, MP3, or any of the like.

For example, a subscriber listens to an interview broadcasted from 10 AM to 11 AM, and sends a request for receiving that interview on 10:30 AM. The subscriber receives the whole interview or only a portion of it, to an email account, FTP folder, mobile phone, radio, or any of the like. The content is especially provided while being broadcasted, or a predetermined period of time afterwards. The subscriber can also request for some of the content to be a ring-tone, and to receive all the content to the email account. Another option is to receive data about the content without receiving the content itself. For example, receiving an SMS while watching a movie, informing the subscriber on who is the director. The subscriber can determine which portion of the audio content will be the ring-tone. The audio content can be sent to the subscriber's cellular phone, for entertainment.

Another option is to request television contents from a specific date, hour and channel. This option is different than the regular Video On demand since the subscriber the subscriber is free from remembering the name of the movie or the name of the person interviewed. The subscriber just needs to write or remember the date hour and channel, and these are enough for the processing unit for providing the content.

Another aspect of the present invention is the ability to request a content while broadcasted. This can be achieved, in a non-limiting manner, by a bottom located on a radio or on a TV set, adapted to perform the act of request certain content to the subscriber. The content can be played to the subscriber online, or to be sent to any storing device the subscriber wishes, such as email account or PC or FTP folder on the internet or on an intranet.

Another aspect of the present invention is to bill subscriber s for providing the VC. The billing is performed according to number of VC's, volume of VC's, monthly payment or any combination thereof. At least one of the subscriber s is licensed with an account, as the act of payment is performed every predetermined period of time, or after a certain amount of VC provided. That amount is characterized by volume, number, memory consumption, and time of broadcast or any combination thereof.

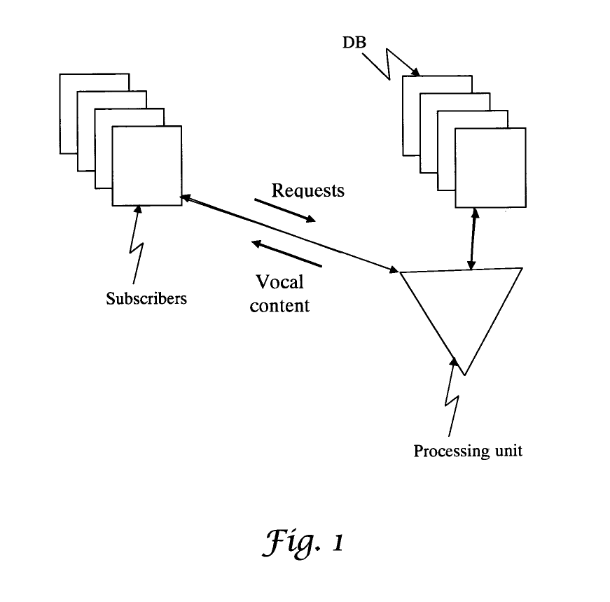

Reference is made now to FIG. 1, schematically shows the connections between the subscribers and the system. The subscribers request media content from the processing unit, which is connected to a database holds many media contents. The request comprises the time, date and station or channel or broadcast. These values are used to retrieve the right content from the database and send it to the subscriber. All that is performed along with billing actions, performed by any billing unit, ensuring payment from the subscriber, either directly or through other party, such as Phone Company or TV supplier.

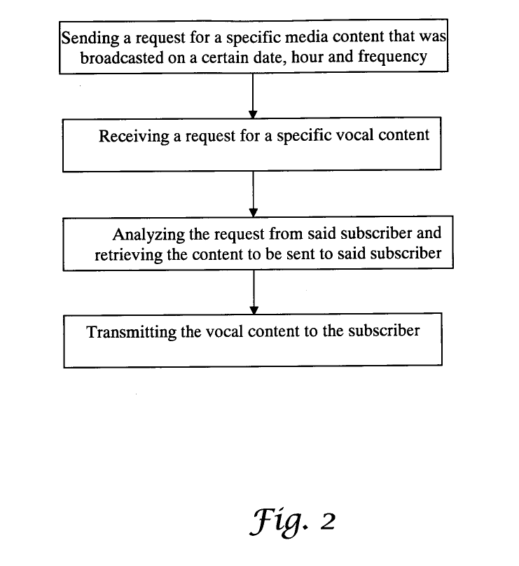

Reference is made now to FIG. 2, schematically shows some of the steps taken in order to provide media content to subscribers. The first step is the request of the content, characterized by date, hour and frequency of broadcasting. Then, the request is processed and the content is retrieved in the database, and then transmitted to the user.

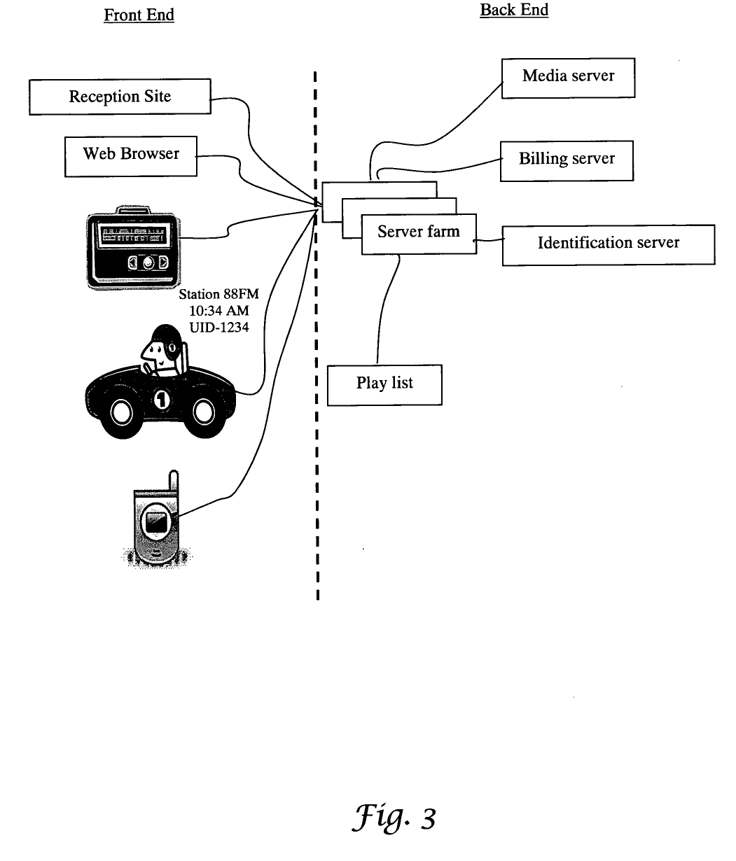

Reference is made now to FIG. 3, schematically shows the subscriber in the car, requesting a specific content. The request is sent to a server, where the processing means is located, or connected to. According to one embodiment of the present invention, the request is done using the radio device. In other embodiments, the request is performed through a mobile phone, the internet, television, regular phone, or any of the like. The processing means is connected to the database holding a plurality of play lists. The server is connected to identification server, for identifying the user, charging server, to ensure successful charging of the user, and to media server, in case the requested content is not on the play lists, try and find other resources such as other subscribers, magazines, websites and more. Another option is to analyze audio signal received from the subscriber in order to determine the vocal content to be provided.

Another option is to provide only data of the content, such as the director, musician, actors, producers, awards, relevant dates and others.

1. A method of providing a determined (vocal, audio video) content to a subscriber, wherein said content is characterized by its broadcasting time, date and (station) frequency of broadcasting of said content; comprising
a. requesting said content by said subscriber;
b. transmitting said request by over a network to a database;
c. billing said subscriber by a predetermined sum of money; and,
d. providing said content to said subscriber.

2. The method according to claim 1, wherein said audio content is selected from a group consists of song, symphony, announcement, advertisement, propaganda broadcast, collection of sounds made by a bird or other animal, poetry, news, articles, interviews, or any combination thereof.

3. The method according to claim 1, wherein said video content is selected from a group consists of video clip, movie, TV show, announcement, advertisement, propaganda broadcast, news, articles, interviews, sport events or any combination thereof.

4. The method according to claim 1, wherein providing said content to the user's computer, email address, phone, TV, radio or any of the like.

5. The method according to claim 1, especially adapted to subscribers while driving.

6. The method according to claim 1, further comprising the step of pressing a bottom located on a radio while listening to an audio content in order to requesting said vocal content.

7. The method according to claim 1, further comprising the step of billing the subscriber for providing said content.

8. The method according to claim 1, wherein providing data regarding said audio or video content, selected from the director, musician, actors, producers, awards, relevant dates and others.

9. The method according to claim 1, wherein providing data is achieved by providing authorization for listening or watching said content on at least one occasion without providing the transmitting said content to the subscriber.

10. A system adapted to provide (vocal, audio video) content to a subscriber over a network wherein said content is requested by the subscriber according to the time, date and frequency of broadcasting of said content, comprising:
a. a processing module, adapted to receive subscriber's requests;
b. a database, storing said content, subscribers communicating details and financial status; and
c. at least one end unit, connected to said processing module; adapted to send the request and receive said content.

11. The system according to claim 10, wherein said end unit is a radio.

12. The system according to claim 11, wherein said radio comprises a bottom adapted to send a request to the processing unit.

13. The system according to claim 10, wherein said end unit is selected from a group consists of mobile phone, FTP folder, computer, email account or any other device having communication means and free storage.

14. The system according to claim 10, additionally comprising billing means, adapted to bill said subscriber according to the volume of content provided, the popularity of said content, memory consumption, duration, number of items provided, or any combination thereof.

15. The system according to claim 14, wherein said subscriber holds one or more accounts in the system, to ease the billing and money and/or money substitute transactions among senders, recipients and the system.

16. The system according to claim 10, wherein said transactions performed after verification and/or identification and/or authentication and/or authorization, by means selected from a group consists of passwords, codes, private knowledge or any combination thereof.

17. The system according to claim 10, further adapted to provide ring-tones to said subscribers.

18. The system according to claim 10, wherein the system is the beneficiary for some of the billing, according to arrangements between the subscriber, the radio station or TV channel and the system.

19. The system according to claim 10, wherein the value for charging the subscriber is limited by the subscriber for one or more actions, to control the charging and ensure that the sender's credit is sufficient before sending said message.
